(19) United States
(12) Patent Application Publication
(10) Pub. No.: US 2008/0309487 A1
(43) Pub. Date: Dec. 18, 2008

(54) CONTAINER MONITORING SYSTEM AND AN ELECTRONIC CONTAINER LOCK

(75) Inventor: Yuan-Ning CHAO, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: TRADE-VAN INFORMATION SERVICES CO., Taipei City (TW)

(21) Appl. No.: 12/138,175

(22) Filed: Jun. 12, 2008

(30) Foreign Application Priority Data
Jun. 12, 2007 (TW) 096121102

(51) Int. Cl. E05B 45/06

(52) U.S. Cl. 340/542

(57) ABSTRACT

A container monitoring system and an electronic container lock are provided according to the present invention; the container monitoring system includes: a first communication device, which is allocated to a container carried by a container vehicle, the first communication device consists of a first communication interface, a monitoring interface, and a lock mechanism that is for locking up door of the container, also the monitoring interface is able to monitor engagement situation of the lock mechanism, and accordingly sending out a first signal if an abnormal situation is detected, subsequently the first signal is sent out via the first communication interface; an intermediate device, which is allocated to the container vehicle, the intermediate device consists of a transmission interface and a first connection interface, the transmission interface is for receiving the first signal transmitted from the first communication device, and then the first signal is transmitted external via the first connection interface; a second communication device, which is allocated to the container vehicle, which has a second communication interface and a second connection interface, the second communication interface is connected to the first connection interface for receiving the first signal transmitted via the first connection interface, and the second communication interface is for transmitting position signal related to location of the container vehicle and the first signal received by the second connection interface; and a cargo tracking terminal, which is for receiving the position signal and the first signal transmitted via the second communication interface of the second communication device; and the electronic container lock has cable winding around door bolts of both right and left door leaves while door of the container being closed, thereby serving as a second device providing security and protection to cargo.

### BACKGROUND OF THE INVENTION

1. Field of the Invention

This invention generally relates to a container monitoring system and an electronic container lock, and more specifically, to a container monitoring system, which is capable of initiatively informing engagement situation of lock bar and lock body of an electronic container lock as well as monitoring situation of vehicle and container through a full cargo transportation progress; and to an electronic container lock, which is capable of enhancing security and protection.

2. Description of Related Art

While the economic growth continues prosperously, international trade is booming as well, and container shipment industry is growing accordingly; and since cargo is transported by means of nothing more than sea transportation, land transportation, and air transportation, also in order to lower transportation cost, sea transportation has become the preferable choice for traders of each nation, wherein container transportation takes a major role in the development of sea transportation.

In order to prevent cargo inside container from being stealthily swapped or stolen, in early stage, a strip seal was applied to seal the door bolt lock, by providing a seal number to the strip seal, customs personnel or marine terminal operator is able to determine if the strip seal is intentionally damaged or replaced by judging if the strip seal is intact and the seal number is correct, and then further determining if the container has been opened illegitimately; however, those who have great intent to stealthily swap or steal the cargo always come up a way to get information on strip seal format and seal number, and then further achieving intentions of swapping or stealing the cargo.

According to foresaid disadvantages, electronic container lock has been developed by the cargo transportation industry to lessen the abovementioned problems; please refer to FIG. 1, which illustrating an established non-contact Radio Frequency Identification (RFID) electronic container lock, in order to simplify illustration and description, followed is only a simple description of structure thereof; as shown in the FIG., the RFID electronic container lock includes a lock bar 10 and a lock head 11, wherein the lock bar 10 is embedded with a RFID chip 100 and a cable plug connection component 102, the chip 100 and the cable plug connection component 102 are electrically connected to each other via a cable 101, also the lock head 11 is disposed with a plug connection component 110 for coupling with the cable 101 inside the lock bar 10, the plug connection component 110 is also connected with an antenna 111; when the lock bar 10 is plugged into the lock head 11, namely locking up, the cable plug connection component 102 inside the lock bar 10 and the plug connection component 110 inside the lock head 11 are engaged with each other, thereby enabling the chip 100 to connect to the antenna 111 inside the lock head 11, and further normally transmitting data signal of the chip 100, also enabling an external reader to access data of the RFID chip 100 of the electronic container lock 1; and the external reader is an electronic device allocated to container vehicle security gate.

However, while applying the electronic container lock, the reader allocated to the container vehicle security gate must coordinate with the RFID chip of the electronic container lock, otherwise, even the RFID electronic container lock has initiatively detected an unlocking situation, it should be passively waited until a reader allocated at the local gate is available to carry out reading process, therefore, this sort of passive monitoring system is incapable of allowing container management to instantly control over container situation.

In addition, foresaid electronic container lock is incapable of enabling the container management to monitor through a full container transportation process if an unlocking situation happens to the electronic container lock; the unlocking situation of the electronic container lock can be only perceived via the reader until the container vehicle reaches the security gate, therefore, if the container management wants to inspect an unlocking situation of the electronic container lock for further perceiving if cargo of the container has been stealthily swapped or stolen, then the container management has to calculate time difference between departure time and arrival time of the container vehicle at gates of departure and arrival, if the time difference is greater than a predicted length of time, indicating an unlocking situation has possibly happened to the electronic container lock during transportation process of the container, also the cargo inside the container has been possibly stealthily swapped or stolen; however, the foresaid method of calculating time difference between departure time and arrival time of the container vehicle is incapable of providing an accurate or instant information of unlocking situation of the electronic container lock, therefore, the established electronic container lock as shown in FIG. 1 is incapable of providing a function for monitoring container through a full transportation process.

Hence, it is a highly urgent issue in the industry for how to provide a technique, which is capable of effectively solving the drawbacks of the prior arts, wherein an electronic container lock is applied in a container transportation process but incapable of practically monitoring the container situation, the electronic container lock has to coordinate with each local reader, thereby incapable of initiatively informing management of the container status, also the prior electronic container lock provides flawed security and protection.

### SUMMARY OF THE INVENTION

In view of the disadvantages of the prior art mentioned above, it is a primary objective of the present invention to provide a container monitoring system, which is capable of achieving objective of managing and controlling over container vehicle and cargo location, accordingly monitoring container through a full container transportation process.

It is another objective of the present invention to provide a container monitoring system, which is capable of initiatively and instantly notifying cargo tracking terminal of cargo transportation status.

It is a further objective of the present invention to provide an electronic container lock, which is capable of enhancing security and protection of the prior electronic container lock.

To achieve the aforementioned and other objectives, a container monitoring system and an electronic container lock are provided according to the present invention; the container monitoring system comprises: a first communication device, which is allocated to a container carried by a container vehicle, further comprising a first communication interface, a monitoring interface, and a lock mechanism for locking up door of the container, the monitoring interface is for monitoring engagement mode of the lock mechanism, and accordingly sending out a first signal if an abnormal status is detected, subsequently the first signal is sent out via the first communication interface; an intermediate device, which is allocated to the container vehicle, comprising a transmission interface and a first connection interface, the transmission interface is for receiving the first signal sent out from the first communication device, and then the first connection interface further transmits the first signal externally; a second communication device, which is allocated to the container vehicle, comprising a second communication interface and a second connection interface, the second connection interface is connected to the first connection interface for receiving the first signal transmitted by the first connection interface, the second communication interface is for sending out a position signal related to location of the container vehicle and the first signal received by the second connection interface; and a cargo tracking terminal, which is for receiving the position signal and the first signal transmitted by the second communication interface of the second communication device.

In another embodiment of said container monitoring system, a monitoring unit is further allocated inside a lock body of the first communication device, the monitoring unit is electrically connected to two ends of at least one cable, thereby allowing the cable to form a closed circuit, also the cable is uncovered from the lock mechanism and winding around bolts of both right and left leaves of the container door when the door being closed, the monitoring unit will transmit a second signal when an open circuit formed by the cable is detected, and then the first communication interface further transmits the second signal to the intermediate device, subsequently the transmission interface of the intermediate device transmits the received second signal to the second communication device via the second connection interface that is connecting with the first connection interface, and then the second communication interface transmits the second signal to the cargo tracking terminal.

The electronic container lock of the present invention comprises a Radio Frequency Identification (RFID) chip, a lock bar, and the lock body for locking up the lock bar, accordingly locking up the container door by engagement mode of the lock bar and the lock body; the RFID chip is for monitoring engagement situation of the lock bar and the lock body and then outputting a situation signal, the situation signal is subsequently received by a reader; features of the electronic container lock are: a monitoring unit is disposed inside the lock body, and the monitoring unit is connecting with two ends of at least one cable, thereby allowing the cable to form a closed circuit, also the cable is uncovered from the lock body and winding around bolts of both right and left leaves of the container door while the door being closed, thereby enabling the monitoring unit to output an open circuit signal while detecting an open circuit of the cable is formed, and providing a reader to access the open circuit signal.

In summary, the container monitoring system of the present invention is characterized by having simple architecture and being capable of enabling the cargo tracking terminal to perceive instantly when the container vehicle is not on a predetermined route or when the container door is opened at unpredetermined time or place; the system of the present invention is also able to execute a corresponding process promptly when any of mentioned perception happens, thereby effectively decreasing happenings of stealthy cargo swap or cargo theft, meanwhile achieving objective of monitoring and managing over the vehicle and container.

### BRIEF DESCRIPTION OF DRAWINGS

The present invention can be more fully understood by reading the following detailed description of the preferred embodiments, with reference made to the accompanying drawings, wherein:

FIG. 1 is a sectional view diagram illustrating a prior electronic container lock;

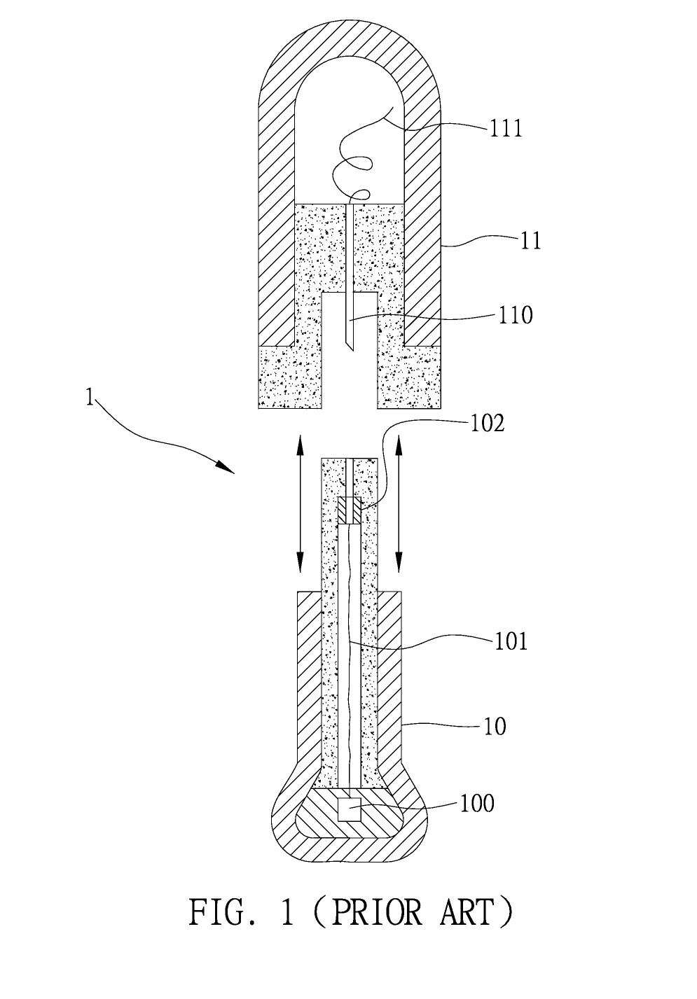

FIG. 2 is an architecture block diagram illustrating application of the container monitoring system of the present invention;

FIG. 3 is a fundamental architecture diagram illustrating the container monitoring system of the present invention; and

FIG. 4 is a fundamental architecture diagram illustrating another embodiment of the first communication device of the container monitoring system of the present invention.

### DETAILED DESCRIPTION OF PREFERRED EMBODIMENTS

The following illustrative embodiments are provided to illustrate the disclosure of the present invention; those in the art can apparently understand these and other advantages and effects after reading the disclosure of this specification. The present invention can also be performed or applied by other different embodiments. The details of the specification may be on the basis of different points and applications, and numerous modifications and variations can be devised without departing from the spirit of the present invention.

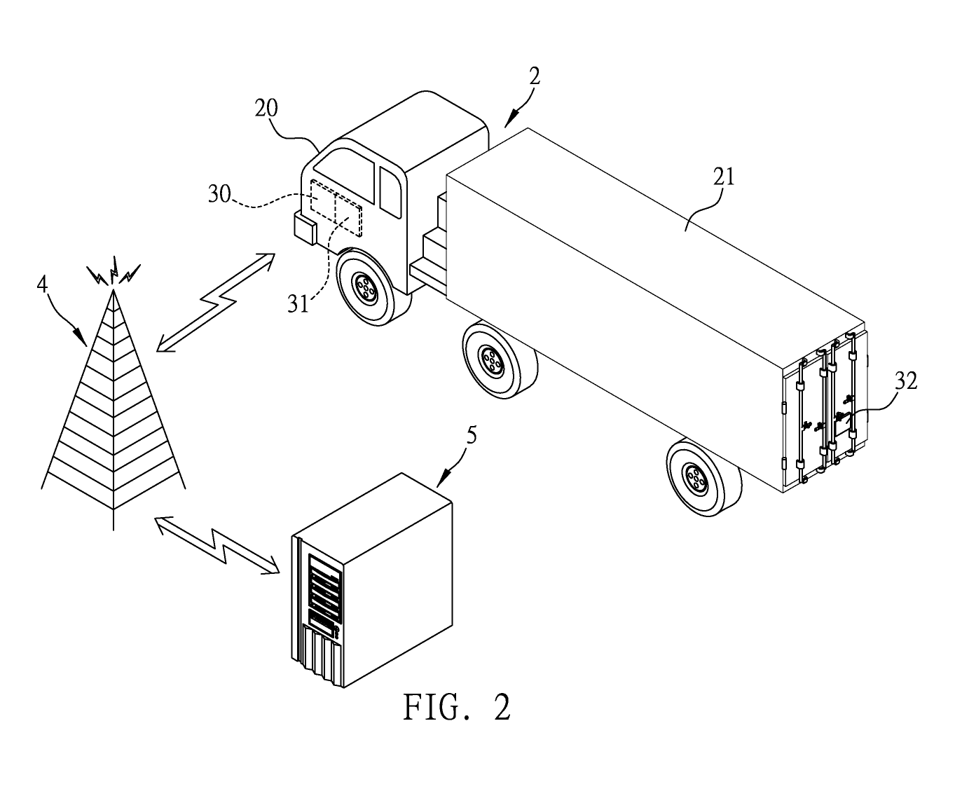

Please refer to FIG. 2, which is an architecture block diagram illustrating application of the container monitoring system of the present invention; as shown in the FIG., the container monitoring system of the present invention comprises a first communication device 32, an intermediate device 31, and a second communication device 30, specifically, the second communication device 30 is for sending information related to container to cargo tracking terminals of, e.g. customers, cargo owner, customers broker, etc., in addition to providing general function of an electronic container lock, the first communication device 32 is for further monitoring if any unlocking situation happens to the electronic container lock and accordingly outputting a corresponding signal; subsequently based on the corresponding signal, a locking status of the electronic container lock, e.g. an unlocking situation, is to be sent to the cargo tracking terminals of, e.g. customers, cargo owner, customers broker, etc., via the intermediate device 31 and the second communication device 30, thereby enabling the cargo tracking terminal to take control over unlocking situation happening to the electronic container lock at any time and any place, also instantaneously acquiring information on location of the container vehicle and the container via the second communication device 30; wherein the container monitoring system of the present invention transmits the information on location of the container vehicle and the container, via a base station 4 or a network transmission equipment (not shown in the FIG.,) to a server 5 and then saved therein for further inquiries at cargo tracking terminals of customers, cargo owner, customers broker, etc.; therefore, the container monitoring system of the present invention is able to reach objective of monitoring and managing over the vehicle and container through a full transportation process, and having no need of readers at security gates as shown in the prior art, thereby providing a simpler system architecture for the purpose of monitoring container.

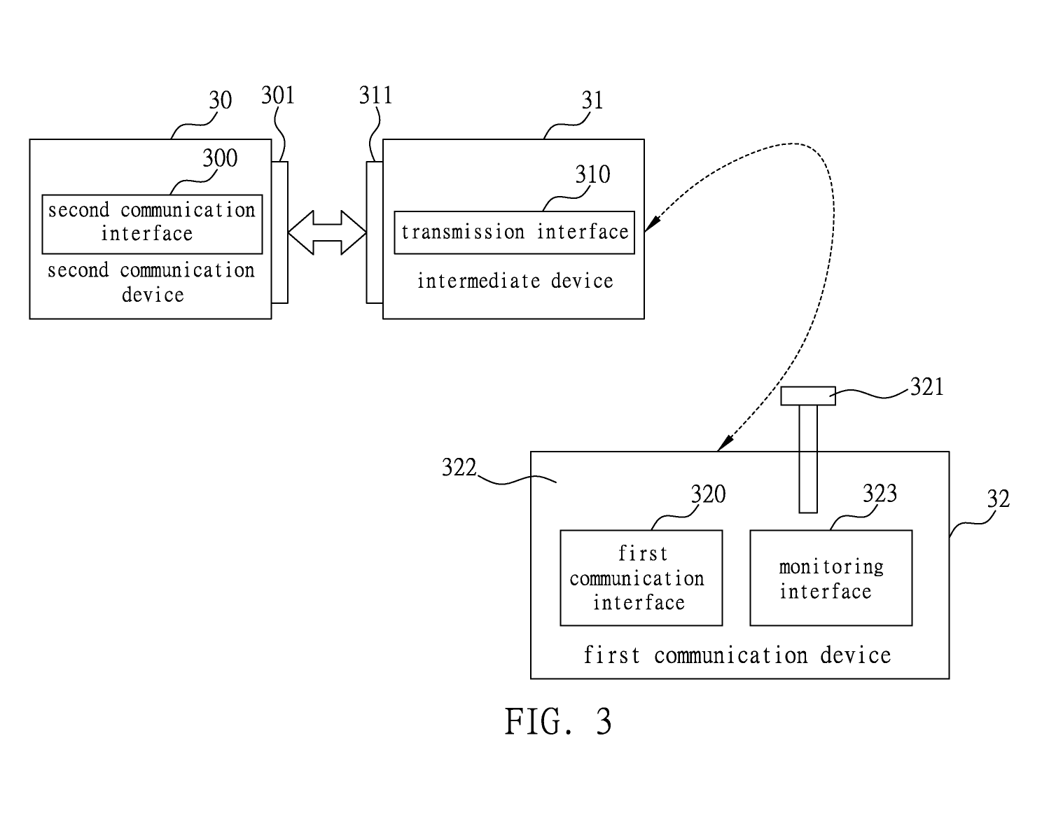

Please refer to FIG. 3, which is a fundamental architecture diagram illustrating the container monitoring system of the present invention; as shown in the FIG., the fundamental architecture of the system comprising a first communication device 32, an intermediate device 31, and a second communication device 30; and followed are detail descriptions of the container monitoring system of the present invention.

The second communication device 30 is allocated to a container vehicle 2 and comprises a second communication interface 300 and a second connection interface 301, the second communication interface 300 is for sending out position signal related to location of the container vehicle 2, in the present embodiment, the second communication device 30 is allocated at driver's cab 20, also the second communication interface 300 is integrated with a signal processing circuit for Global Position System (GPS) and a processing circuit for wireless telephone system, such as General Packet Radio Service (GPRS), digital Global System for Mobile (GSM), or others; in other words, the position signal of the container vehicle 2 is acquired by the signal processing circuit for GPS of the second communication interface 300, and then the position signal of the container vehicle 2 acquired by the signal processing circuit for GPS is subsequently transmitted out via the processing circuit for GPRS, and further being sent to the server 5 via the base station 4 or network transmission equipment; on the other hand, the second communication interface 300 of the second communication device 30 is further capable of receiving the first signal transmitted from the first communication device 32, detailed description of purposes of sending the first signal by the first communication device 32 and receiving the first signal by second communication device 30 will be given later.

The intermediate device 31 is allocated to the container vehicle 2, in the present invention, the intermediate device 31 is allocated at the drive's cab 20, and also the intermediate device 31 comprises a first connection interface 311 and a transmission interface 310; the first connection interface 311 and the second connection interface 301 of the second communication device 30 are electrically connected to each other; the second connection interface 301 and the first connection interface 311 are, e.g. RS-232 interfaces; and the transmission interface 310 is a communication interface applying ZigBee protocol; the ZigBee protocol, which is a new standard for short distance wireless transmission, adopts IEEE802.15.4 as foundation, applies frequency band of 2.4 GHz to 900 MHz with transmission range of about 10 meters and transmission speed of 250 Kbps, and has dual communication capability; since the ZigBee protocol has established transmission standard, no further detailed description of functions and architecture thereof is to be given hereafter; the first signal sent from the first communication device 32 is received by the transmission interface 310, detailed description of purposes of sending the first signal by the first communication device 32 and receiving the first signal by the intermediate device 31 will be given later.

The first communication device 32 is allocated to a container 21 carried by the container vehicle 2 and comprises a first communication interface 320 and a monitoring interface 323; the monitoring interface 323 is, e.g. a non-contact Radio Frequency Identification (RFID) chip, and the first communication device 32 further comprises a lock mechanism for locking up door of the container and preventing the container door from being stealthily opened, and the lock mechanism is, e.g. a prior electronic container lock; in the present embodiment, the lock mechanism comprises a lock bar 321 and a lock body 322 for locking up the lock bar 321; it should be stated herein, since plug connection structures of the lock bar 321 and the lock body 322 are standard components of a common electronic container lock, and also to simplify illustration and description, no further detailed description thereof is to be given hereafter.

In the present embodiment, the first communication interface 320 of the first communication device 32 and the transmission interface 310 of the intermediate device 31 are ZigBee protocol communication interfaces, thereby enabling the intermediate device 31 and the first communication device 32 to carry out signal transmission wirelessly; the monitoring interface 323 is for monitoring locking situation of the lock rod 321 and the lock body 322, if a separation situation of the lock rod 321 and the lock body 322 is detected, namely the electronic container lock is in an unlocking situation, then outputting the first signal; the separation situation of the lock rod 321 and the lock body 322 indicates a possible situation that the container door is opened, and if door is opened not at a predetermined time orplace as information saved in cargo tracking terminal, indicating a great possibility that the cargo inside the container has been stealthily swapped or stolen; accordingly, the container monitoring system of the present invention is capable of enabling the cargo tracking terminal to perceive foresaid situation promptly; specifically, if the monitoring interface 323 detects a situation that the lock bar 321 is separated from the lock body 322, then outputting and transmitting the first signal to the first communication interface 320, subsequently the first communication interface 320 transmits the first signal to the transmission interface 310 that is a same interface as the first communication interface 320; next, the intermediate device 31 transmits the first signal received by the transmission interface 310 to the second communication device 30 via the second connection interface 301 that is electrically connected to the first connection interface 311, subsequently the first signal is further transmitted to a server 5 by the processing circuit for GPRS provided by the second communication interface 300 via a base station 4 or a network transmission equipment, and then the server saves the first signal; furthermore, the second communication interface 300 is integrated with the signal processing circuit for GPS, therefore, while transmitting the first signal, position signal of the container vehicle 2 acquired after being processed by the signal processing circuit for GPS is transmitted to the server 5, and the sever 5 saves the position signal for further inquiry about location of the container vehicle and container at cargo tracking terminal of customers, cargo owner, customers broker, or others.

In view of the above, the container monitoring system of the present invention is capable of initiatively notifying cargo tracking terminal of cargo status, thereby effectively solve drawback of the prior art, wherein electronic container lock has to coordinate with reader thereby passively informing of container status and incapable of controlling over container status promptly; in addition, the container monitoring system of the present invention is capable of perceiving situations promptly when the container vehicle 2 is not on a predetermined route as information saved in the cargo tracking terminal, or when container door is opened not at a predetermined time or place as information saved in the cargo tracking terminal, thereby effectively decreasing happenings of stealthy cargo swap and cargo theft, meanwhile achieving objective of monitoring and managing over vehicle and container through a full transportation process.

Beside, according to the container monitoring system of the present invention, the second communication device 30 and the intermediate device 31 are electrically connected to each other via, e.g. RS-232 connection interfaces; and the intermediate device 31 and the first communication device 32 process wireless transmission therebetween via, e.g. ZigBee communication interfaces, accordingly, when the cargo is transported within a region with different telephone support system, only the second communication device 30 has to be switched in accordance with local telephone system; therefore, while working on a different telephone system region, the container monitoring system of the present invention is still capable of providing foresaid container monitoring function after switching second communication device 30 in accordance with the local telephone system.

In addition, according to the prior art, the prior electronic container lock is restricted by security gate reader and thus incapable of practically monitoring over the container through the full transportation process or while traveling somewhere else; while in the present invention, the first communication device 32 is capable of effectively solving foresaid drawbacks of the prior art by adopting transmission architecture of the second communication device 30 and the intermediate device 31 and the server 5.

Furthermore, the intermediate device 31 and the second communication device 30 are electrically connected to each other via connection between the first connection interface 311 and the second connection interface 301; in addition to said RS-232 connection interface specification, in another embodiment, the first connection interface 311 and the second connection interface 301 can be integrated into one serial bus line, meanwhile all other components of the second communication device 30 and the intermediate device 31 are integrated onto a same circuit board, in other words, the second communication device 30 and the intermediate device 31 are built inside an electronic apparatus; however, it is not restricted to as stated herein, there are various integration approaches applicable to various application modes.

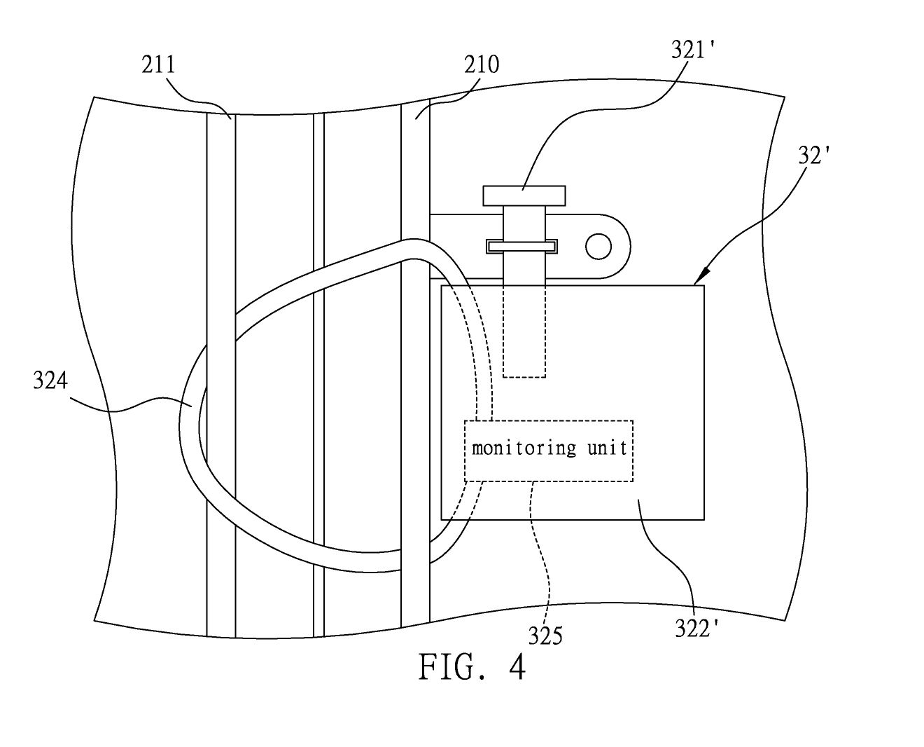

Please refer to FIGS. 3 and 4, wherein FIG. 4 is a fundamental architecture diagram illustrating another embodiment of the first communication device of the container monitoring system of the present invention; as shown in the FIGS., in the present embodiment, a monitoring unit 325 is disposed inside the lock body 322′ of the first communication device 32′, and the monitoring unit 325 is electrically connected to two ends of at least one cable 324, thereby enabling the cable 324 to form a closed circuit; the cable 324 is a wire capable of generating closed circuit signal and open circuit signal, e.g. a cable line, fiber optic cable, or other; also the cable 324 is uncovered from the lock body 322′ and winding around bolt of right door leaf 210 and bolt of left door leaf 211 while the container door being closed, a pair of positioning holes are formed on the lock body 322′, not shown in the FIGS., for the two ends of the cable 324 to be positioned inside the positioning holes respectively, also enabling the two ends of the cable 324 to be contained inside the lock body 322′ and electrically connected to the monitoring unit 325; when the monitoring unit 325 detects that the cable 324 forms an open circuit, namely the cable 324 has been cut off, indicating a possible situation that the container door has been opened, then the monitoring unit 325 outputs a second signal, namely an open circuit signal, and the second signal is transmitted to the intermediate device 31 via the first communication interface 320, subsequently, the transmission interface 310 of the intermediate device 31 transmits the received second signal to the second communication device 30 via the second connection interface 301 connecting with the first connection interface 311, and then the second communication interface 300 transmits the second signal to the cargo tracking terminal.

In addition to said electronic container lock, the cable 324 can also serves as a second security and protection over cargo inside the container 21 against stealthy swap and theft of the cargo, also security level can be raised by adding additional cables, e.g. adding two or more cables; in other words, more cables provides a higher security level.

Besides, the cable 324 of the first communication device 32′ and the monitoring unit 325 are also applicable to the prior electronic container lock, specifically, integrating said cable 324 and said monitoring unit 325 into the lock bar, lock body, and RFID chip of the prior electronic container lock; accordingly, when the monitoring unit 325 detects that an open circuit of the cable 324 is formed, then outputting an open circuit signal, subsequently the open circuit signal disables the RFID chip from receiving signal, correspondingly, disabling external reader from acquiring situation of the electronic container lock, thereby enabling container management to perceive that the container door has been opened, and then taking a corresponding action.

In summary, the container monitoring system of the present invention is capable of solving the drawback of the prior art, wherein the prior electronic container lock is incapable of enabling the container management to monitor and control over the vehicle and container through a full transportation process; furthermore, the electronic container lock of the present invention is capable of enhancing security and protection function of the prior electronic container lock, therefore, compared with the prior container management technique and container lock security technique, the present invention provides preferable advancement and practicability.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A container monitoring system, which comprises:
a first communication device coupled to a container that is carried by a container vehicle, and comprising a first communication interface, a monitoring interface, and a lock mechanism for locking up door of the container, wherein the monitoring interface is configured to monitor engagement mode of the lock mechanism, so as to accordingly send out a first signal via the first communication interface if an abnormal status is detected;
an intermediate device mounted in the container vehicle, and comprising a transmission interface for receiving the first signal sent from the first communication device, and a first connection interface connected to the transmission interface for sending out the first signal;
a second communication device mounted in the container vehicle, and comprising a second communication interface and a second connection interface, wherein the second connection interface is connected to the first connection interface for receiving the first signal sent by the first connection interface, and the second communication interface is used to send out a position signal related to location of the container vehicle and the first signal received by the second connection interface; and
a cargo tracking terminal for receiving the position signal and the first signal sent from the second communication interface of the second communication device.

2. The container monitoring system of the claim 1, wherein the second communication interface is integrated with a signal processing circuit for Global Position System (GPS) and a processing circuit for wireless telephone system, such that, when the second communication interface sends out the first signal via the processing circuit for wireless telephone system, the position signal of the container vehicle acquired after being processed by the signal processing circuit for GPS is capable of being sent out by the second communication interface.

3. The container monitoring system of claim 2, wherein the processing circuit for wireless telephone system is either General Packet Radio Service (GPRS) or Global System for Mobile (GSM.)

4. The container monitoring system of claim 1, wherein the lock mechanism comprises a lock bar and a lock body, such that the first signal sent from the first communication interface is used to indicate that the lock bar and the lock body are in a separation status.

5. The container monitoring system of claim 1, wherein the cargo tracking terminal is a server and is for storing the received first signal and the position signal.

6. The container monitoring system of claim 1, wherein the second connection interface and the first connection interface are RS-232 transmission interfaces.

7. The container monitoring system of claim 1, wherein the transmission interface and the first communication interface are communication interfaces applying ZigBee protocol.

8. The container monitoring system of claim 1, wherein the lock mechanism is further provided with a monitoring unit electrically connected with two ends of at least one cable, thereby enabling the cable to form a closed circuit, and the cable is exposed to the lock mechanism and winds around door bolts of both right and left leaves of the container door while the door is closed, such that the monitoring unit will output a second signal when an open circuit formed by the cable is detected, and then the first communication interface further outputs the second signal to the intermediate device, for the transmission interface of the intermediate device to transmit the received second signal to the second communication device via the second connection interface connected with the first connection interface, so as for the second communication interface to transmit the second signal to the cargo tracking terminal.

9. The container monitoring system of claim 8, wherein the cable is a cable line or a fiber optic cable.

10. The container monitoring system of claim 8, wherein the cargo tracking terminal is a server for storing the received second signal.

11. An electronic container lock, comprising a non-contact Radio Frequency Identification (RFID) chip, a lock bar, and a lock body for locking up the lock bar, allowing a container door to be locked by engagement of the lock bar and the lock body; wherein the RFID chip is for monitoring engagement situation of the lock bar and the lock body and outputting a situation signal to a reader; the electronic container lock being characterized in: a monitoring unit is disposed in the lock body and connected with two ends of at least one cable, thereby allowing the cable to form a closed circuit, wherein the cable is exposed to the lock body and winds around bolts of both right and left leaves of the container door while the door is closed, thereby enabling the monitoring unit to output an open circuit signal while detecting that an open circuit of the cable is formed, and enabling the reader to access the open circuit signal.

12. The electronic container lock of claim 11, wherein the cable is a cable line or a fiber optic cable.
